(19) United States
(12) Patent Application Publication
(10) Pub. No.: US 2007/0001647 A1
(43) Pub. Date: Jan. 4, 2007

(54) Device for measuring a battery energy, in particular during charge/discharge of a battery

(75) Inventors: Carmine D'Avanzo, Conza (IT); Guglielmo De Rosa, Conza (IT)

Correspondence Address: YOUNG & THOMPSON, 745 SOUTH 23RD STREET, 2ND FLOOR, ARLINGTON, VA, 22202, US

(73) Assignee: AWELCO INC. S.P.A., Conza (IT)

(21) Appl. No.: 11/097,202

(22) Filed: Apr. 4, 2005

(30) Foreign Application Priority Data
Apr. 2, 2004 (IT) RM2004A000171

(51) Int. Cl. H02J 7/00

(52) U.S. Cl. 320/132

(57) ABSTRACT

A device for measuring a battery energy, in particular during charge/discharge of a battery, includes supply elements (3) apt to be connected to a battery (5) so as to make an electric current flow in/from the latter for one or more time intervals, and controlling and detecting elements (2), characterised in that the controlling and detecting elements (2) are apt to detect the energy stored in the battery (5) during a time period including at least one portion of the one or more time intervals.

The present invention concerns a device for measuring, preferably ampere-hour, energy of a battery, in particular during battery charge/discharge.

More in detail, the present invention concerns a device apt to measure ampere-hours, in particular studied and implemented for use in the context of recharging devices for batteries or electrical accumulators, but which may be used in any case where it is necessary to measure the value of the energy that has been transferred from the charger to the battery.

In the following, the description will be directed to the application of the device, that is subject matter of the present invention, to a battery charger, but it is well evident that the same application has not to be considered as limited to this specific use.

Many different types of battery chargers are presently available in commerce, which are used for recharging electrical accumulators, or batteries, for industrial traction, for cars, or for several applications. These equipments provides battery recharge through more or less sophisticated systems. In fact, present battery chargers provide from the simple manual recharging current adjusting up to the complete automatism of the whole recharge process.

Said equipments are generally provided with a series of measuring instruments apt to indicate the battery charge state. For instance, said instruments may be a voltmeter and/or an amperometer. Moreover, signallers of several types are present, which allow to display values of instant current and/or instant voltage during recharging, and also a charge end state or other functions of the same charger. This signalling may also be reported on a display in terms of battery instant voltage, recharging instant current, etc.

Although the described instrumentations may also be very sophisticated, present battery chargers lack an instrument that measures and displays the value of ampere-hour of a charge, i.e. the value of the energy that has been transferred from the charger to the battery.

It is known to the skilled in the art that ampere-hour indicates the measurement unit of the battery capacity and it is defined as “the current suppliable during discharge, suitably delivered up to reach the final voltage”. Therefore the ampere-hour is the product of the current intensity (measured in amperes) transmitted to the battery by the duration (in hours) of said current transmission. It is known that the quantity of electricity (capacity) of a battery or of a cell is normally expressed in ampere-hour [Ah]. Measuring this value is important since it determines the real battery state, that is the real capacity of storing energy.

In view of the above, it appears evident the need for an available instrument measuring the ampere-hours, such as the one proposed according to the present invention.

In this context, it is included the solution proposed according to the present invention.

It is therefore an object of the present invention to propose a device for measuring the ampere-hours to be applied, in particular, to battery charger apparatuses.

It is therefore specific subject matter of the present invention a device for measuring a battery energy, in particular during charge/discharge of a battery, comprising supply means apt to be connected to a battery so as to make an electric current flow in/from the latter for one or more time intervals, and controlling and detecting means, characterised in that said controlling and detecting means is apt to detect the energy stored in said battery during a time period comprising at least one portion of said one or more time intervals.

Still according to the invention, said controlling and detecting means may be apt to detect said stored energy through an integration in said time period of said current flowing in/from the battery.

Furthermore according to the invention, said controlling and detecting means may comprise at least one microcontroller.

Always according to the invention, said device may further comprise enabling means, controlled by said controlling and detecting means, apt to enable or disable the flow of said current in/from the battery and said enabling means may comprise at least one thyristor, said controlling and detecting means controlling triggering and/or turning-off of said at least one thyristor.

Still according to the invention, said supply means may comprise a power supply unit, apt to provide a periodic voltage, said controlling and detecting means may comprise a unit of detection of the voltage provided by the power supply unit, and said controlling and detecting means may control triggering and/or turning-off of said at least one thyristor on the basis of the detected voltage provided by the power supply unit.

Furthermore according to the invention, said controlling and detecting means may comprise means of detection of the current flowing in said at least one thyristor.

Preferably according to the invention, said controlling and detecting means may control acoustic and/or visual signalling means, such as a display.

Always according to the invention, said supply means may be apt to be connected to a battery through pliers means, and said controlling and detecting means may comprise means of detection of at least one voltage applied to said pliers means.

Still according to the invention, said controlling and detecting means, when it detects that said at least one applied voltage is not positive, may be apt to control said enabling means so as to disable the flow of said current in/from the battery. Furthermore according to the invention, said controlling and detecting means, when it detects that said at least one applied voltage reaches at least one corresponding threshold voltage value, may be apt to control said enabling means so as to disable the flow of said current in/from the battery.

Preferably according to the invention, said at least one corresponding threshold voltage value may be selectable by a user.

Always according to the invention, said controlling and detecting means may comprise interruption means activable by a user, following the activation of which said controlling and detecting means may control said enabling means so as to disable the flow of said current in/from the battery.

Furthermore according to the invention, said controlling and detecting means, when it detects that said time period reaches a corresponding threshold time value, may be apt to control said enabling means so as to disable the flow of said current in/from the battery.

Preferably according to the invention, said threshold time value may be selectable by a user.

Still according to the invention, said controlling and detecting means is apt to detect an energy efficiency Reₜ, for each recharge-discharge cycle t, of said battery, equal to the ratio
Reₜ=Wh₀ₜ/Wh₁ₜ
where Wh₀ₜ is the electric energy obtainable during a discharge of said battery at the cycle t and Wh₁ₜ is the electric energy needed for a recharge of said battery at the cycle t.

Furthermore according to the invention, said controlling and detecting means may be apt to detect the residual electric energy Whᵢₙₜ of said battery during a discharge step during the cycle t, equal to
Whᵢₙₜ=Reₜ₋₁·Wh₁ₜ−Whᵤₜ
where Reₜ₋₁ is the energy efficiency of recharge-discharge of said battery during the preceding cycle t−1, Wh₁ₜ is the electric energy of recharge of said battery at the cycle t and Whᵤₜ is the electric energy obtained from said battery before its complete discharge during said cycle t.

Always according to the invention, said controlling and detecting means may comprise means of detection of the temperature of said enabling means.

Preferably according to the invention, said controlling and detecting means may activate at least one cooling fan when it detects that said temperature reaches a first corresponding threshold temperature value.

Furthermore according to the invention, said controlling and detecting means, when it detects that said temperature reaches a second corresponding threshold temperature value, may be apt to control said enabling means so as to disable the flow of said current in/from the battery.

Still according to the invention, said controlling and detecting means may activate at least one cooling fan when it detects that said electric current flowing in/from the battery reaches a corresponding threshold current value.

The present invention will now be described, by way of illustration and not by way of limitation, according to its preferred embodiments, by particularly referring to the Figures of the enclosed drawings, in which:

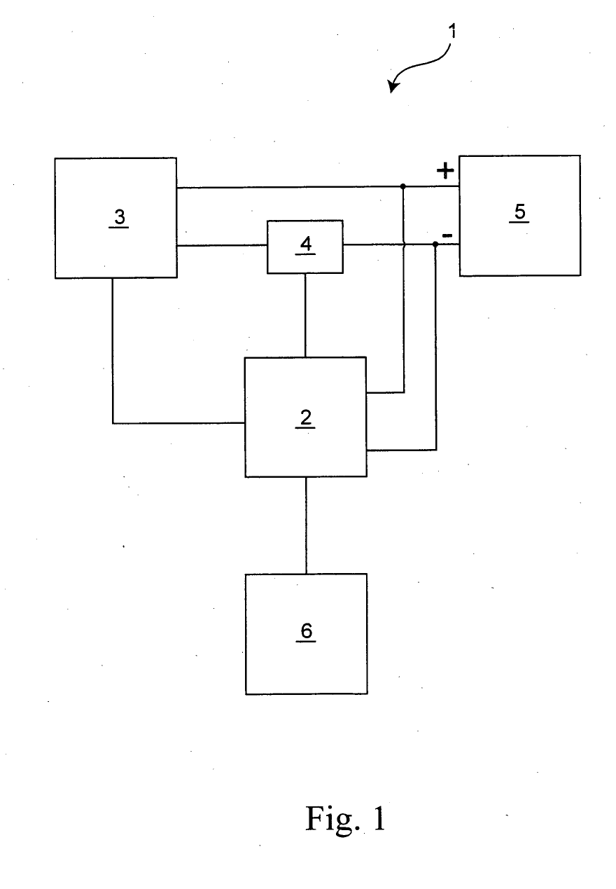

FIG. 1 shows a block diagram of a preferred embodiment of the device for measuring ampere-hours according to the present invention;

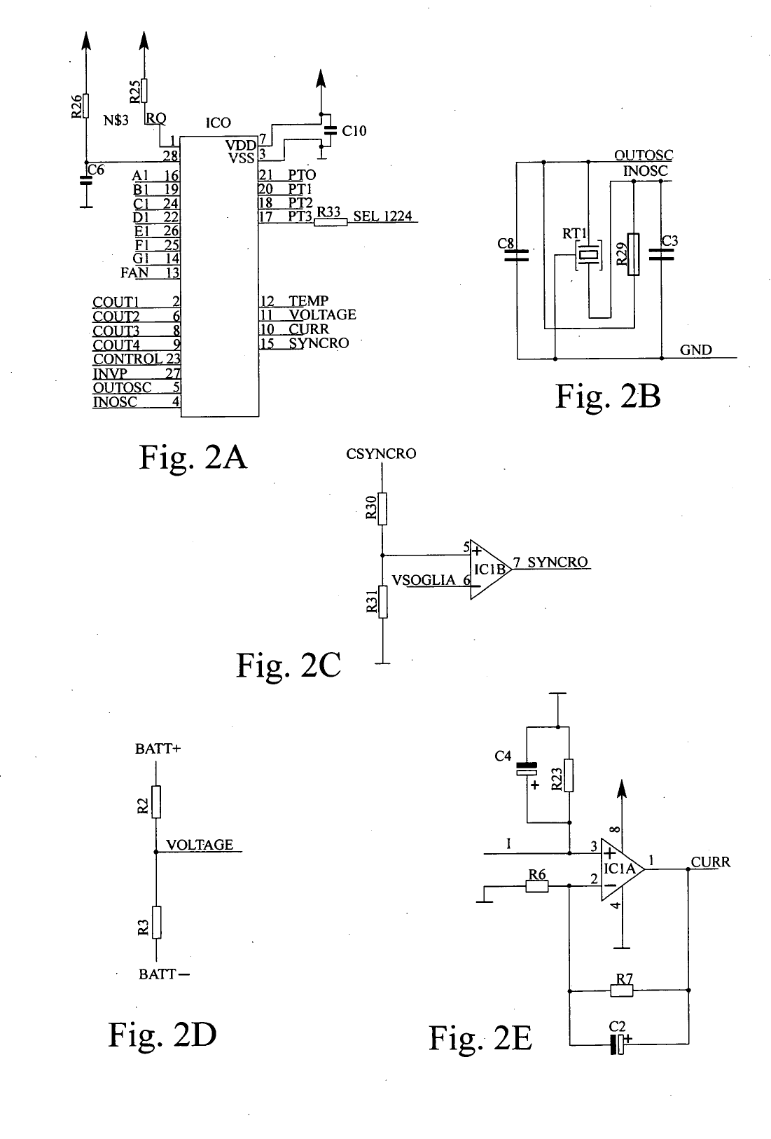

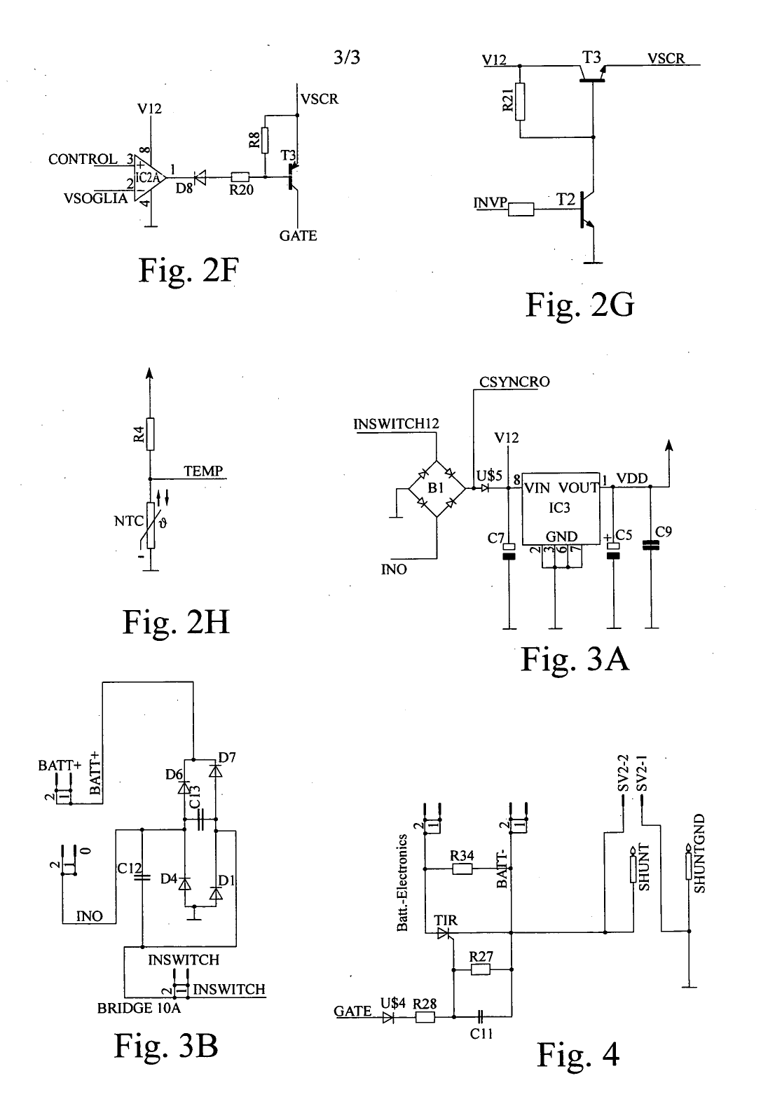

FIGS. 2A-2H show some detailed circuit diagrams of a first portion of the device of FIG. 1;

FIGS. 3A-3B show some detailed circuit diagrams of a second portion of the device of FIG. 1; and

FIG. 4 shows a detailed circuit diagram of a third portion of the device of FIG. 1.

In the following description same references will be used for indicating alike elements in the Figures.

Making reference to FIG. 1, it is possible to observe the block diagram of a preferred embodiment of the device 1, that mainly comprise a control block 2, a power supply block 3, for supplying the device logic and providing the power supply for charging the battery 5, and a unit 4 for controlling the power supply current of said battery 5.

The control block 2 detects voltage and current charging the battery 5, taking account of delays and/or overloads, through a series of possible auxiliary circuits, not shown in the Figure. Through said detections, said control block 2 is capable to control the connection of the battery with ground, either or not short-circuiting the branch, through the current control unit 4, precisely calculating the value of the ampere-hours transmitted to the battery, and it is capable to display the latter on a display unit 6, such as for instance a display. In other words, through the control block 2, the device 1 may precisely calculate the current absorbed by the battery 5, and it may detect the charge times with maximum precision and synchronism. Finally, the control block 2 evaluates the ampere-hours transmitted on the basis of the data obtained from said detections.

In the following Figures it is possible to observe some circuit diagrams of the preferred embodiment of the device according to the invention, based on the block diagram of FIG. 2.

FIG. 2A shows a microcontroller, referred to as IC0. This corresponds to a part of the control block 2 of FIG. 2. Said microcontroller IC0 provides terminal groups suitable for specific functions. Terminals A1, B1, C1, D1, E1, F1, G1, and COUT 1-4 control a liquid crystal display, not shown in Figure, that allows displaying information on the battery charge, such as, for instance, voltage, charge time, and ampere-hours transmitted to the battery.

Terminals OUTOSC and INOSC are connected to the circuit shown in FIG. 2B. This is a quartz resonant circuit, referred to as RT1, provided with a passive network, and it generates a clock signal for the microcontroller IC0.

In FIG. 3A, a circuit is present that corresponds to a part of the power supply block 3 of FIG. 1. This has two input terminals INSWICH12 and INO which represent a 12 Volt output of the secondary of a transformer (not shown in the Figure). Said two terminals are connected to the rectifier bridge B1. A stabilising circuit is present in cascade to said rectifier bridge B1, formed by the integrated circuit IC3, by a diode D1, and by capacitive components. IC3 is capable to generate a constant voltage VDD for supplying device logic parts.

Power supply circuit for recharging the battery (being also part of the power supply block 3 of FIG. 1) is shown in FIG. 3B. The connection to the battery positive terminal, through pliers BATT+, occurs through a rectifier bridge, made of diodes D1-D4, that rectifies the sinusoid coming from terminal taps INO and INSWITCH of the secondary of the aforecited transformer, not shown in the Figures.

The voltage is taken at the output of the rectifier bridge B1 of FIG. 3A, through connection CSYNCRO, which voltage is processed by means of the circuit of FIG. 2C (belonging to the control block 2 of FIG. 1). The voltage of CSYNCRO is partitioned by the two resistors R1 and R2, placed at the input of the operational amplifier IC1-B, and it is compared with a threshold voltage VSOGLIA (preferably equal to the value of voltage drop on a conducting diode). As soon as the voltage CSYNCRO exceeds said threshold voltage VSOGLIA, the op-amp IC1-B generates an positive output signal, that is brought to the terminal SYNCRO of the microcontroller IC0, that converts said analog signal in a digital signal.

The just described circuit, that generates the signal SYNCRO, allows determining points wherein the voltage on the rectifier bridge is 0 Volt or lower than a certain threshold (equal to VSOGLIA). In other words, it is zero-detect circuit.

Besides the indication of the signal SYNCRO, the microcontroller IC0 detects the voltage on the battery, brought to the terminal VOLTAGE through the divider R4-R5 of FIG. 2D (being part of the control block 2 of FIG. 1) interposed between the terminals of the battery (i.e. between pliers BATT+ and BATT_ELETTRONICS− of the device), and the current transmitted to the battery, through a signal proportional to it on the terminal CURR.

Said current is proportional to that flowing on the thyristor TIR of FIG. 4, where the circuit diagram of the current control unit 4 of FIG. 1 is shown. Considering the circuit of FIG. 2E (being also part of the control block 2 of FIG. 1), detection of said current is possible through the op-amp IC1-A, in non inverting amplifier configuration, that is dedicated to amplify a current signal I, coming from a shunt (not shown in the Figures) placed between the contacts SHUNTGND, SHUNT, i.e. between SV2-1 and SV2-2, of FIG. 4. The signal, proportional to said current I, at the output of the op-amp IC1-A is connected, as said before, to the terminal CURR of IC0, and it is converted from analog to digital.

Through detection of the battery voltage, of the instant charge current, passing through the thyristor TIR, of the value of voltage at the input of the thyristor TIR, the microcontroller IC0 is capable to determine the turn-on delay of TIR.

Turn-on of TIR is still driven by IC0, through the output CONTROL. The analog signal on the terminal CONTROL is still compared with the threshold voltage VSOGLIA by the op-amp IC2-A of the circuit of FIG. 2F (that is still part of the control block 2 of FIG. 1), and amplified in current by the transistor T1, the collector of which is connected to the gate of the thyristor TIR, and it is capable to provide it with the gate current needed for triggering it. In this way it is possible to precisely drive TIR, synchronising triggering with the supply half wave provided by the circuit of FIG. 3B, and allowing IC0 to precisely calculate the instant in which the current passing through TIR, i.e. being transferred to the battery, is to be detected.

A system allowing the thyristor TIR to be powered off is also provided. This is obtained through the terminal INVP, driving the transistor T2 of the circuit of FIG. 2G (being always part of the control block 2 of FIG. 1), “mirror connected” with the transistor T3, that supplies the transistor T1 of FIG. 2F through the branch VSCR. Therefore, by means of T2 it is possible to cut T1 off and turn TIR off.

When TIR is on, it allows the connection to ground of the battery negative terminal through first pliers BATT_ELETTRONICS−.

In FIG. 4 further pliers BATT− is also shown that optionally allows the direct connection of the battery negative terminal to ground, enabling recharge with no control by the control block 2 of FIG. 1.

Once TIR is on, it conducts and the battery is able to be recharged. The recharge current is detected in real time by IC0, through the circuit of FIG. 2E, and it is stored so as to allow the ampere-hours to be calculated in a subsequent step. In fact, the microcontroller IC0 has the control of the triggering turn-off instants of the thyristor TIR, and therefore it may calculate the lapse of recharge time and hence the quantity of transferred energy (equal to the integration in time of the instant charge current).

Preferably, the microcontroller IC0 also provides a control allowing temperature effects on the thyristor TIR to be compensated. In particular, making reference to the circuit of FIG. 2H (being part of the control block 2 of FIG. 1), a resistor NTC, variable with temperature, is provided, that is connected as a divider with a resistor, placed in proximity of the transformer (not shown) and of the thyristor TIR. Said divider generates a voltage proportional to the temperature, that is brought to the terminal TEMP of IC0. IC0, through the terminal FAN, is capable to control a fan, allowing both the transformer and the thyristor TIR to be cooled.

During the recharge cycle, the microcontroller IC0 calculates the ampere-hour value of the energy stored in the battery, through substantially an integration in time of the charge current.

In particular, the value of the current transferred from the thyristor TIR (when triggered) to the battery is measured (or rather sampled) in each second. Such value is accumulated in a sum.

On completion of the charge cycle, the sum of the current values detected in each second is transformed in ampere-hours, i.e. amperes*hours, (i.e. the sum value, that is represented in amperes*seconds, is divided by 3600) and it is displayed on the display up to the power off of the battery charger.

Preferably, the thyristor TIR is definitely powered off (i.e. the charge cycle is interrupted) when a predetermined voltage value, possibly selectable by a user, is reached.

On the basis of the preceding description, it may be observed that the fundamental characteristics of the present invention is that of carrying out a synchronised detection of the charge (and possibly discharge) current of a battery and of the charge (and possibly discharge) time of a battery.

An advantage of the present invention is the fact that the ampere-hour meter may be also applied for measuring the number of ampere-hours during the discharge of the storage battery and therefore it is possible to detect the “energy efficiency” of said storage battery. In fact, as it is known, the energy efficiency is the “ratio between the electric energy (Wh) obtainable during discharge and the one consumed during charge”. Therefore, such energy efficiency is equal to the ratio Re=Wh₀/Wh₁, where Re is the energy efficiency, Wh₀ is the electric energy obtainable during discharge, and Wh₁ is the electric energy needed for recharge. Knowledge of the energy efficiency Re (updated at each recharge because it is a function of the battery ageing) allows us to obtain the effective Wh₀=Wh₁·Re, and hence by the ampere-hour meter according to the invention it is possible to measure the effective quantity of current available from a battery while the latter is more and more used.

The device according to the invention is extremely reliable, ensuring: protection against short-circuit and polarity reversal on pliers BATT+ and BATT_ELETTRONICA− (or BATT−), thermal protection, and automatic charge stop.

In particular, protection against short-circuit of the pliers BATT+ and BATT_ELETTRONICA− and against polarity reversal (connection of the pliers on reverse polarities of the battery) occurs through the thyristor that at the power-on of the battery charger is off. The microcontroller IC0 cyclically acquires the battery voltage and the output circuit remains off until the voltage remains null, whereby no voltage is present on the output pliers. The same thing occurs if a negative voltage is detected at the positive element of the pliers (i.e. the output pliers are reverse-connected to the battery poles), and the output circuit still remains off. Vice versa, when the microcontroller IC0 detects that the output pliers have been correctly connected to the battery, the charge cycle starts.

The thermal protection may comprise the interruption of the charge cycle (by suitably driving the thyristor TIR) until the predetermined limit temperature persists.

The microcontroller IC0 may also activate the fan for cooling the power circuit when a predetermined value of current provided by the thyristor TIR to the battery is exceeded.

Preferably, the charge cycle may further end I the case when the user, through an external intervention (for instance selection of a switch), decides to stop the battery charge, or in the case when a maximum charge time, possibly selectable by the user, expires.

The ampere-hour meter subject matter of the present invention, being capable to measure the energy stored in or output from a battery, may also be used for detecting the effective residual energy within the same battery. In fact, through said device, it is possible to calculate Wh₁, that is the electric energy obtainable during a charge, and Wh₀, that is the electric energy obtainable during the corresponding discharge. In this manner, the battery efficiency Re is obtained as Re=Wh₀/Wh₁.

In the successive charge cycle t, the ampere-hour meter is capable to detect the new charge energy Wh₁ₜ. Therefore, while the battery is in use, the ampere-hour meter is capable to evaluate the electric energy drawn from said battery, before the discharge at the discharge cycle t, Whᵤₜ, so obtaining the still residual one Whᵢₙₜ within the battery,
Whᵢₙₜ=Reₜ₋₁·Wh₁ₜ−Whᵤₜ
Reₜ₋₁ is the energy efficiency of the preceding charge-discharge cycle t−1, while Wh₁ₜ is the electric energy stored in the battery 5 during the last charge step. Obviously, the energy efficiency Re is updated at each charge-discharge cycle. In this way, it is possible to take account of the battery deterioration with time, which will tend to lessen the capacity of the same to store energy during the charge step.

The present invention has been described, by way of illustration and not by way of limitation, according its preferred embodiments, but it should be understood that those skilled in the art can make variations and/or changes, without so departing from the related scope of protection, as defined by the enclosed claims.

1. Device for measuring a battery energy, in particular during charge/discharge of a battery, comprising supply means (3) apt to be connected to a battery (5) so as to make an electric current flow in/from the latter for one or more time intervals, and controlling and detecting means (2), characterised in that said controlling and detecting means (2) is apt to detect the energy stored in said battery (5) during a time period comprising at least one portion of said one or more time intervals.

2. Device according to claim 1, characterised in that said controlling and detecting means (2) is apt to detect said stored energy through an integration in said time period of said current flowing in/from the battery (5).

3. Device according to claim 1, characterised in that said controlling and detecting means (2) comprises at least one microcontroller (IC0).

4. Device according claim 1, characterised in that it further comprises enabling means (4), controlled by said controlling and detecting means (2), apt to enable or disable the flow of said current in/from the battery (5).

5. Device according to claim 4, characterised in that said enabling means (4) comprises at least one thyristor (TIR), said controlling and detecting means (2) controlling triggering and/or turning-off of said at least one thyristor (TIR).

6. Device according to claim 5, characterised in that said supply means (3) comprises a power supply unit (D1-D4), apt to provide a periodic voltage, in that said controlling and detecting means (2) comprises a unit (R1, R2, IC1-B) of detection of the voltage provided by the power supply unit (D1-D4), and in that said controlling and detecting means (2) controls triggering and/or turning-off of said at least one thyristor (TIR) on the basis of the detected voltage provided by the power supply unit (D1-D4).

7. Device according to claim 5, characterised in that said controlling and detecting means (2) comprises means (IC1-A) of detection of the current flowing in said at least one thyristor (TIR).

8. Device according to claim 1, characterised in that said controlling and detecting means (2) controls acoustic and/or visual signalling means (6).

9. Device according to claim 8, characterised in that said acoustic and/or visual signalling means (6) comprises a display.

10. Device according to claim 4, characterised in that said supply means (3) are apt to be connected to a battery (5) through pliers means (BATT+, BATT_ELETTRONICA−), and in that said controlling and detecting means (2) comprises means (R4, R5) of detection of at least one voltage applied to said pliers means (BATT+, BATT_ELETTRONICA−).

11. Device according to claim 10, characterised in that said controlling and detecting means (2), when it detects that said at least one applied voltage is not positive, is apt to control said enabling means (4) so as to disable the flow of said current in/from the battery (5).

12. Device according to claim 10, when depending on claim 4, characterised in that said controlling and detecting means (2), when it detects that said at least one applied voltage reaches at least one corresponding threshold voltage value, is apt to control said enabling means (4) so as to disable the flow of said current in/from the battery (5).

13. Device according to claim 12, characterised in that said at least one corresponding threshold voltage value is selectable by a user.

14. Device according to claim 4, characterised in that said controlling and detecting means (2) comprises interruption means activable by a user, following the activation of which said controlling and detecting means (2) controls said enabling means (4) so as to disable the flow of said current in/from the battery (5).

15. Device according to claim 4, characterised in that said controlling and detecting means (2), when it detects that said time period reaches a corresponding threshold time value, is apt to control said enabling means (4) so as to disable the flow of said current in/from the battery (5).

16. Device according to claim 15, characterised in that said threshold time value is selectable by a user.

17. Device according to claim 1, characterised in that said controlling and detecting means (2) is apt to detect an energy efficiency Reₜ, for each recharge-discharge cycle t, of said battery (5), equal to the ratio
Reₜ=Wh₀ₜ/Wh₁ₜ
where Wh₀ₜ is the electric energy obtainable during a discharge of said battery (5) at the cycle t and Wh₁ₜ is the electric energy needed for a recharge of said battery (5) at the cycle t.

18. Device according to claim 17, characterised in that said controlling and detecting means (2) is apt to detect the residual electric energy Whᵢₙₜ of said battery (5) during a discharge step during the cycle t, equal to
Whᵢₙₜ=Reₜ₋₁·Wh₁ₜ−Whᵤₜ
where Reₜ₋₁ is the energy efficiency of recharge-discharge of said battery (5) during the preceding cycle t−1, Wh₁ₜ is the electric energy of recharge of said battery (5) at the cycle t and Whᵤₜ is the electric energy obtained from said battery (5) before its complete discharge during said cycle t.

19. Device according to claim 4, characterised in that said controlling and detecting means (2) comprises means (NTC) of detection of the temperature of said enabling means (4).

20. Device according to claim 19, characterised in that said controlling and detecting means (2) activates at least one cooling fan when it detects that said temperature reaches a first corresponding threshold temperature value.

21. Device according to claim 19, characterised in that said controlling and detecting means (2), when it detects that said temperature reaches a second corresponding threshold temperature value, is apt to control said enabling means (4) so as to disable the flow of said current in/from the battery (5).

22. Device according to claim 1, characterised in that said controlling and detecting means (2) activates at least one cooling fan when it detects that said electric current flowing in/from the battery (5) reaches a corresponding threshold current value.

23. Device according to claim 1, characterised in that said supply means (3) are apt to be connected to a battery (5) through pliers means (BATT+, BATT_ELETTRONICA−), and in that said controlling and detecting means (2) comprises means (R4, R5) of detection of at least one voltage applied to said pliers means (BATT+, BATT_ELETTRONICA−).
